(19) United States
(12) Patent Application Publication
(10) Pub. No.: US 2003/0161057 A1
(43) Pub. Date: Aug. 28, 2003

(54) Device and method for actuating and positioning vehicular monitoring device

(75) Inventors: Wen-Wei Su, Taoyuan (TW); Kuei-Hung Chen, Taoyuan (TW); Shun-Hsiang Hsiao, Taoyuan (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Exon Science, Inc., Taoyuan (TW)

(21) Appl. No.: 10/374,795

(22) Filed: Feb. 25, 2003

(30) Foreign Application Priority Data
Feb. 25, 2002 (CN) 02105274.3

(51) Int. Cl. G02B 5/08; G02B 7/18

(52) U.S. Cl. 359/844

(57) ABSTRACT

A device for actuating and positioning a vehicular monitoring device responsive to a vehicular status indicator, includes an actuating device in communication with the vehicular status indicator and the vehicular monitoring device, and a positioning device in communication with the vehicular monitoring device and the actuating device. The actuating device actuating the vehicular monitoring device to move from an initial position to a working position in response to the enabled vehicular status indicator, and actuating the vehicular monitoring device to return to the initial position in response to the disabled vehicular status indicator. The positioning device asserts a positioning signal to the actuating device according to a current position of the vehicular monitoring device for the reference of the actuating device.

### FIELD OF THE INVENTION

The present invention relates to an actuating and positioning device, and more particular to a device for actuating and positioning a vehicular monitoring device responsive to a vehicular status indicator. The present invention also relates to a method for actuating and positioning a vehicular monitoring device responsive to a vehicular status indicator.

### BACKGROUND OF THE INVENTION

When a driver is seated in a vehicle, he should adjust all of the interior and exterior rearview mirrors according to his need. The rearview mirror can be adjusted manually or automatically by pushing buttons. After the adjustment of rearview mirrors is done, the view angle of each rearview mirror seen by the driver is constant, and it is difficult and also dangerous for the driver to further change the view angles while driving.

In practice, when a driver would like to change to another lane, turn to another direction or overtaking a car, he will need to realize more about the situation of the adjacent lane to see whether there is any vehicle oncoming. Therefore, the horizontally turning of the rearview mirror toward the target lane will be helpful for the lane-changing or overtaking operation. In addition, while moving up or down a slope, it is advantageous to turn the rearview mirror vertically to obtain a view range similar to that on the flat road.

Taiwanese Patent Publication Nos. 388377, 465498, 448874 and 448875 issued to Sun (Taipei, Taiwan, R.O.C) and 459637 to Hsieh (Hsinchu, Taiwan, R.O.C) and co-pending U.S. patent application Ser. Nos. 09/946,094 and 10/047,762 assigned to the present assignee, which are incorporated herein for reference, disclose the automatic movement of rearview mirrors according to the driving situations of a vehicle so that the driver can have an improved view angle without manually adjusting the rearview mirrors while driving. These techniques, although create a flexible view range for the vehicle, cause a new problem.

Please refer to FIG. 1 which is a schematic block diagram showing a rearview mirror assembly of the prior art, allowing the mirror to move in a two-dimensional manner. Under the control of the control circuit 13, the mirror 10 can be driven to rotate in a horizontal direction and a vertical direction by the motors 11 and 12, respectively. In the prior art, the control circuit 13 provides driving current to optionally actuate either or both of the motors 11 and 12 so as to drive the mirror 10 to rotate. In other words, the moving extent of the mirror depends on the intensity and the activated time of the driving current. Since the motors 11 and 12 are implemented by direct-current (DC) motors, they may provide differential driving force for the mirror 10 in forward and backward rotation. The mirror 10 are thus likely to deviate from the originally set position, i.e. the best position for regular driving, after a certain number of rotation cycles.

### SUMMARY OF THE INVENTION

Therefore, an object of the present invention is to provide a device and a method for actuating and positioning the rearview mirror, which allows the rearview mirror to recover to the originally set position after automatically rotating to enlarge the view angle as mentioned above.

A first aspect of the present invention relates to a device for actuating and positioning a vehicular monitoring device responsive to a vehicular status indicator. The device includes an actuating device in communication with the vehicular status indicator and the vehicular monitoring device, actuating the vehicular monitoring device to move from an initial position to a working position in response to a first operation status of the vehicular status indicator, and actuating the vehicular monitoring device to return to the initial position in response to a second operation status of the vehicular status indicator; and a positioning device in communication with the vehicular monitoring device and the actuating device, asserting a positioning signal to the actuating device according to a current position of the vehicular monitoring device for the reference of the actuating device.

Preferably, the first operation status of the vehicular status indicator is an enabled status, and the second operation status is a disabled status.

Preferably, the positioning signal is referred by the actuating device to precisely locate the initial position.

In an embodiment, the current position of the vehicular monitoring device is determined according to an electric potential signal outputted by the vehicular monitoring device.

In an embodiment, the current position of the vehicular monitoring device is determined according to the pulse number of a bi-level square-wave signal outputted by the vehicular monitoring device.

In an embodiment, the positioning device includes a proximity switch that is disposed at a position corresponding to the initial position.

In an embodiment, the positioning device includes a peak detector.

The vehicular monitoring device can be a rearview mirror or an assembly of a camera and a display.

The vehicular status indicator can be one selected from a group consisting of an electronic compass, a global positioning system (GPS), a telematics system, an attitude indicator, a vehicle stability control system, and a yaw sensor included in an electronic stability program (ESP).

The positioning signal can be transmitted via a vehicular cable system or a vehicular digital bus such as a controller area network (CAN) or a vehicle area network (VAN) bus.

Preferably, a movement speed of the vehicular monitoring device between the initial position and the working position depends on a velocity of the vehicle.

A second aspect of the present invention relates to a method for actuating and positioning a vehicular monitoring device responsive to a vehicular status indicator. The method includes steps of actuating the vehicular monitoring device to move from an initial position to a working position in response to a first operation status of the vehicular status indicator; actuating the vehicular monitoring device to move from the working position toward the working position in response to a second operation status of the vehicular status indicator; and asserting a positioning signal according to a current position of the vehicular monitoring device on the way from the working position to the initial position for precisely locating the initial position.

In an embodiment, an electric potential outputted by the vehicular monitoring device is used to indicate the current position of the vehicular monitoring device.

In an embodiment, a pulse number of a bi-level square-wave signal outputted by the vehicular monitoring device is used to indicate the current position of the vehicular monitoring device.

In an embodiment, the positioning signal is asserted when the vehicular monitoring device approaches the initial position to a certain extent.

In an embodiment, the step for asserting the positioning signal includes sub-steps of: detecting and recording a first and a second periods of time T1 and T2 for the vehicular monitoring device to move and return between two dead ends, respectively, under a constant power source; recording a third period of time T3 for the vehicular monitoring device to move from the initial position to the working position under the constant power source; calculating a fourth period of time T4 for the vehicular monitoring device to move from the working position to the initial position under the constant power source by using the first, second and third periods of time T1, T2 and T3 to perform an interpolation method; and asserting the positioning signal according to the fourth period of time T4 .

A third aspect of the present invention relates to another method for actuating and positioning a vehicular monitoring device responsive to a vehicular status indicator. The method comprises steps of: presetting a first and a second actuating power for moving and returning the vehicular monitoring device between an initial position and a working position, the first and the second actuating powers are different from each other; actuating the vehicular monitoring device to move from the initial position to the working position with the first electric level of actuating voltage in response to a first operation status of the vehicular status indicator; and actuating the vehicular monitoring device to move from the working position to the working position with the second electric level of actuating voltage in response to a second operation status of the vehicular status indicator.

In an embodiment, the difference of the first and the second actuating power are conducted by providing different electric levels of actuating voltages. For example, it can be implemented by a dip switch.

In an embodiment, the difference of the first and the second actuating power are conducted by providing a constant electric level of actuating voltage for different periods of time. For example, it can be implemented by a microcontroller.

### BRIEF DESCRIPTION OF THE DRAWINGS

The present invention may best be understood through the following description with reference to the accompanying drawings, in which:

FIG. 1 is a schematic functional block diagram showing the two-dimensional rotation of a rearview mirror according to prior art;

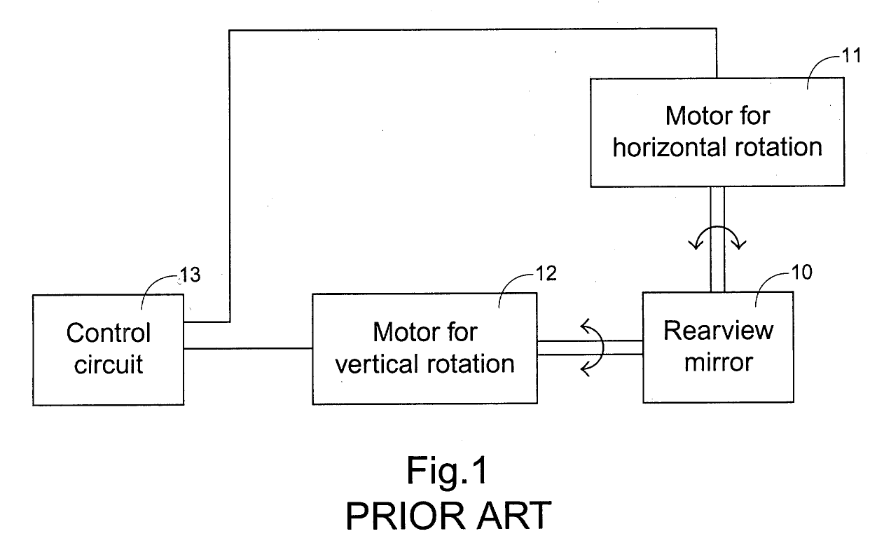

FIG. 2 is a schematic circuit block diagram showing the main structure of the actuating and positioning device according to the present invention;

FIG. 3 is a schematic circuit block diagram showing an actuating and positioning device according to a first preferred embodiment of the present invention;

FIG. 4 is a schematic circuit block diagram showing an actuating and positioning device according to a second preferred embodiment of the present invention;

FIG. 5 is a schematic circuit block diagram showing an actuating and positioning device according to a third preferred embodiment of the present invention;

FIG. 6 is a schematic circuit block diagram showing an actuating and positioning device according to a fourth preferred embodiment of the present invention; and

FIG. 7 is a schematic circuit block diagram showing an actuating and positioning device according to a fifth preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

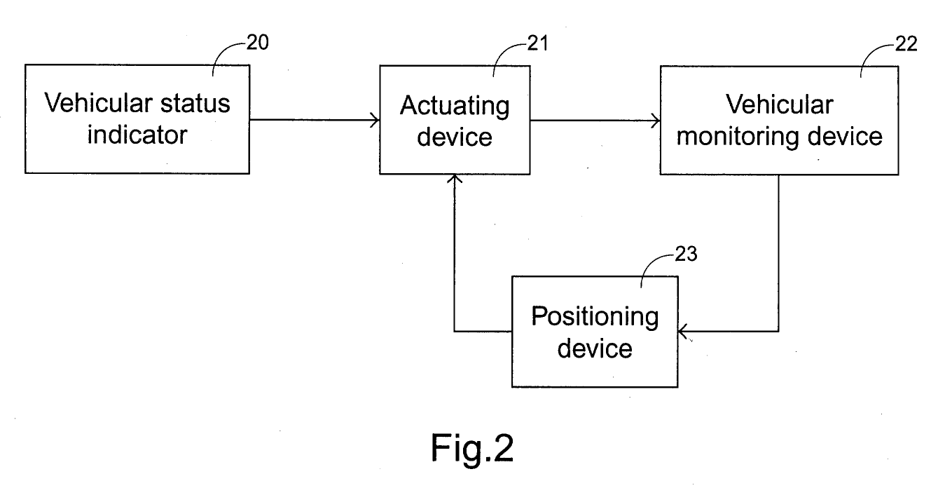

Referring to FIG. 2, the main structure of the present actuating and positioning device is shown. The actuating and positioning device controls the movement of a vehicular monitoring device responsive to the operation of a vehicular status indicator. The vehicular monitoring device, for example, can be a rearview mirror module, a combination of a camera such as a CCD or CMOS camera and a display such as a liquid crystal display, or any other vehicular monitoring device having an adjustable view range. Herein and hereinafter, the term “move”, “moving”, “moved” or “movement” broadly means the change of the vehicular monitoring device on location, orientation, zooming effect etc., due to for example shift, rotation, pivoting or the combination thereof, in order to obtain a suitable view range. The vehicular status indicator, for example, can be an electronic compass, a global positioning system (GPS), a telematics system, an attitude indicator, a vehicle stability control system, or a yaw sensor included in an electronic stability program (ESP). Some of the output signals indicate the turning operation of the vehicle, some indicate the slope change of the vehicle, and others indicate the speed change of the vehicle. For example, in the case that the vehicle is climbing up a slope, the rearview mirror is preferably turned downwards in response to the control signal. For the case that the vehicle is suddenly changing up, the two rearview mirrors are both rotated outwards for facilitating the overtaking operation.

As shown in FIG. 2, the actuating and positioning device includes an actuating device 21 in communication with the vehicular status indicator 20 and the vehicular monitoring device 22, and a positioning device 23 in communication with the actuating device 21 and the vehicular monitoring device 22. When the vehicular status indicator 20 indicates a status change of the vehicle, the vehicular monitoring device 22 is actuated by the actuating device 21 to move from an initial position to a working position to result in a suitable view range for the reference of the driver. When the operation status of the vehicle returns normal, the vehicular monitoring device 22 is actuated by the actuating device 21 to return the initial position from the working position. Meanwhile, the positioning device asserts a positioning signal to the actuating device according to the current position of the vehicular monitoring device for the reference of the actuating device in order to precisely locate the initial position.

The implementation of the actuating device can refer to the conventionally used one, e.g. a motor or motors in the vertical and horizontal directions. The operational examples of the positioning device are illustrated as follows by using a turning-direction indicator light module as the vehicular status indicator and a rearview mirror as the vehicular monitoring device. When the left or right indicator light is enabled, the motor drives the corresponding rearview mirror to move from an initial position suitable for straight travel outwards to a working position where the adjacent lane can be seen clearly. On the contrary, when the indicator light is disabled, the motor drives the rearview mirror to return the working position from the working position.

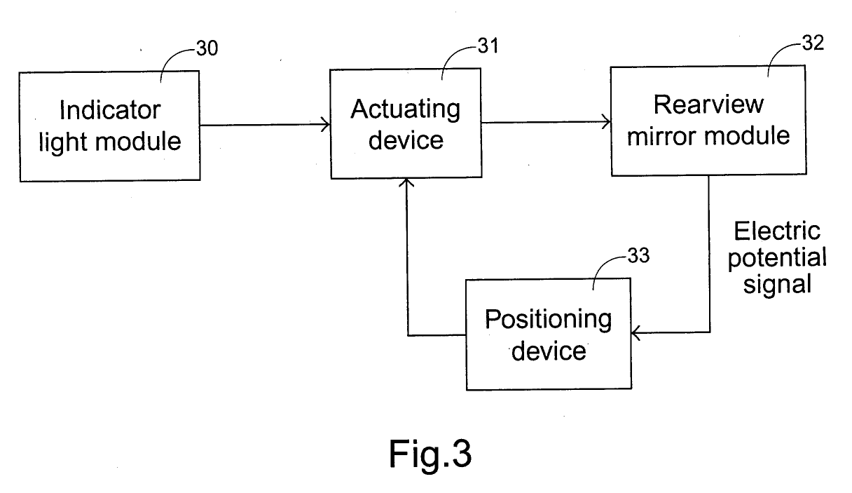

Please refer to FIG. 3 which is a schematic circuit block diagram showing an actuating and positioning device according to a first preferred embodiment of the present invention. The positioning device 33 locates the initial position according to an electric potential signal outputted by the rearview mirror module 32 and varying with the current position of the rearview mirror module 32. The variation of electric potential with the current position of the rearview mirror module 32 can be conducted by providing a variable resistor (not shown) to the rearview mirror module 32. With the movement of the rearview mirror, different positions of the variable resistor are indicated to result in different electric levels. When the mirror is moved from the initial position to the working position, the electric potential data are recorded in advance. Once the mirror is moved from the working position toward the initial position, the electric potential signal indicative of the current electric level is transmitted to the positioning device 33, and compared with the recorded data to locate the initial position. When the comparing result indicates the coming of the initial position, the positioning device 33 asserts the positioning signal to the motor to stop driving. The function of the positioning device 33, for example, can be implemented by a microcontroller.

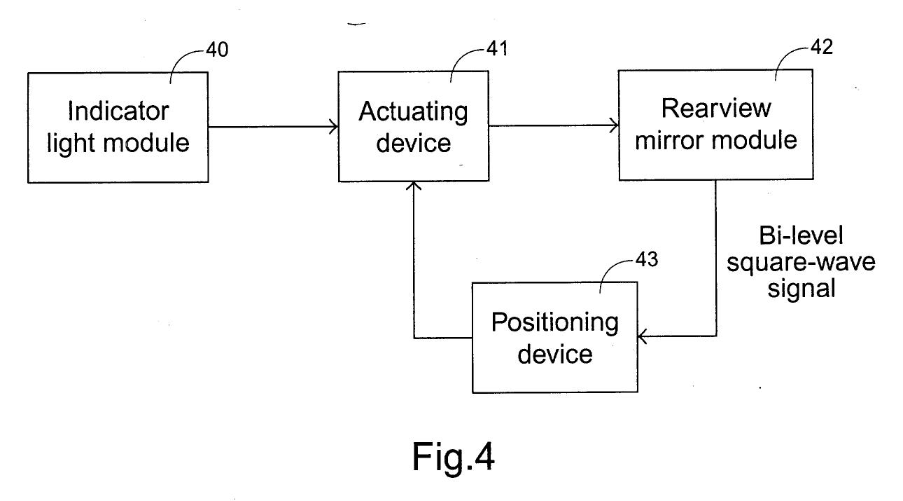

Please refer to FIG. 4 which is a schematic circuit block diagram showing an actuating and positioning device according to a second preferred embodiment of the present invention. The positioning device 43 locates the initial position according to the pulse number of a bi-level square-wave signal outputted by the rearview mirror module 42, which varies with the current position of the rearview mirror module 42. The variation of electric potential with the current position of the rearview mirror module 42 can be conducted by providing a photoelectric encoder module (not shown) to the rearview mirror module 42. With the movement of the rearview mirror, different pulse numbers are detected by the photoelectric encoder module. When the mirror is moved from the initial position to the working position, the pulse number data are recorded in advance. Once the mirror is moved from the working position toward the initial position, the pulse number information is outputted to the positioning device 43, and compared with the recorded data to locate the initial position. When the comparing result indicates the coming of the initial position, the positioning device 43 asserts the positioning signal to the motor to stop driving. The photoelectric encoder module, for example, can include a light emitter, a grid wheel and a light detector. The function of the positioning device 43, for example, can be implemented by a microcontroller. example, can be implemented by a microcontroller.

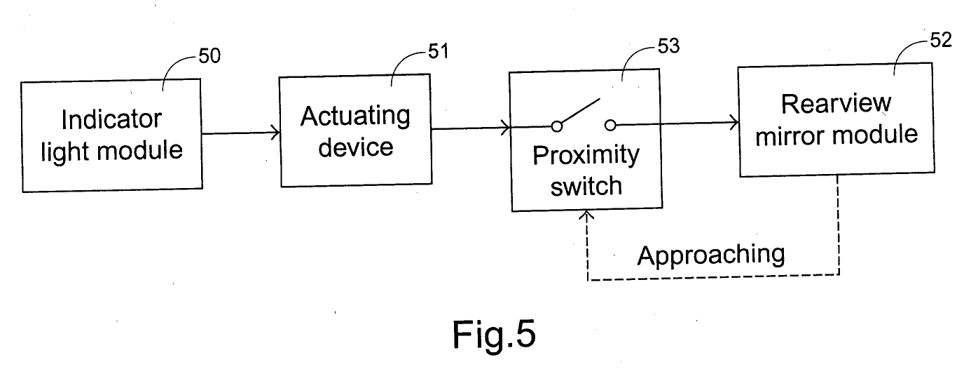

Please refer to FIG. 5 which is a schematic circuit block diagram showing an actuating and positioning device according to a third preferred embodiment of the present invention. The positioning device 53 is a proximity switch in the embodiment. The proximity switch is located at the initial position of the rearview mirror module 52. When the mirror is moved from the working position toward the initial position, and approaches the proximity switch to a certain extent, the positioning device 53 asserts the positioning signal to the motor to stop driving.

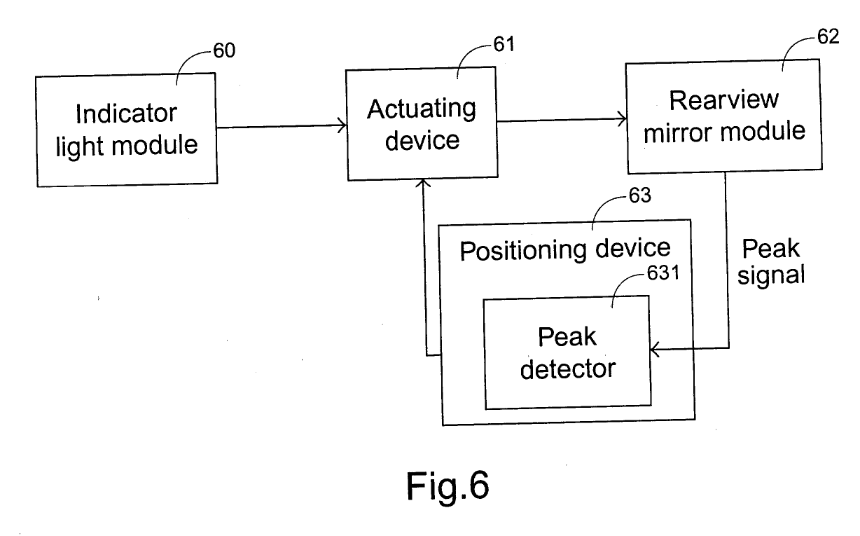

Please refer to FIG. 6 which is a schematic circuit block diagram showing an actuating and positioning device according to a fourth preferred embodiment of the present invention. The positioning device 63 includes a peak detector 631, and locates the initial position by use of an interpolation method. A first and a second periods of time T1 and T2 for the vehicular monitoring device to move and return between two dead ends, respectively, under a constant power source are first detected and recorded by the peak detector 631. Further, a third period of time T3 for the vehicular monitoring device to move from the initial position to the working position under the constant power source is detected and recorded. Accordingly, a fourth period of time T4 for the vehicular monitoring device to move from the working position to the initial position under the constant power source can be calculated by using the first, second and third periods of time T1, T2 and T3 to perform an interpolation operation (T4=T3×T2/T1). In other words, when the mirror is moved from the working position toward the initial position, it is determined that the initial position is reached once the fourth period of time T4 is up. Meanwhile, the positioning device 63 asserts the positioning signal to the motor to stop driving.

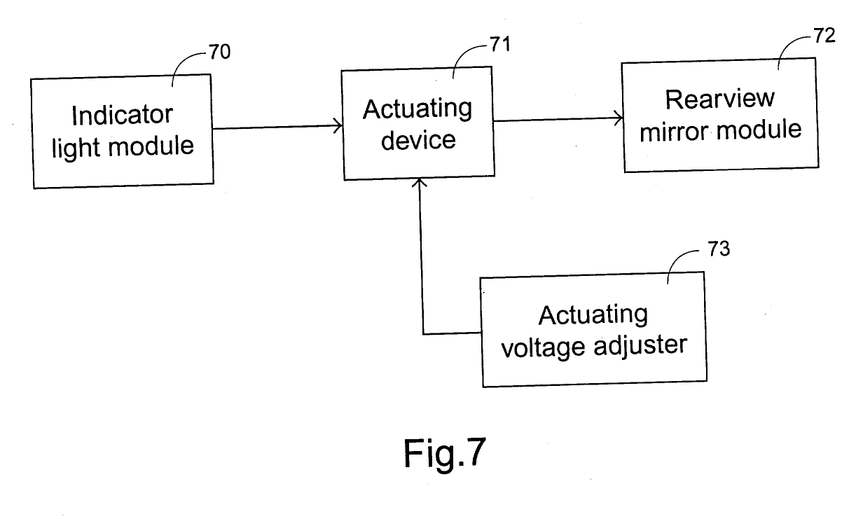

Alternatively, the positioning operation can be preset in stead of dynamically monitoring the current position of the rearview mirror. Please refer to FIG. 7 which is a schematic circuit block diagram showing an actuating and positioning device according to a fifth preferred embodiment of the present invention. The positioning device 73 is in communication with the motor(s) 71 but not with the rearview mirror module 72. By realizing the respective actuating powers for the travel from the initial position to the working position and the counter-travel from the working position to the initial position in advance, different actuating powers are provided for the travel and the counter-travel. The differentiation of the actuating powers can be achieved by changing actuating voltage or actuating time. For example, by using a dip switch as the positioning device 73, different actuating voltages can be applied to the travel and the counter-travel to result in the desired different actuating powers. By using a microcontroller as the positioning device 73, different actuating time under the same actuating voltage can be applied to the travel and the counter-travel to result in the desired different actuating powers.

In another aspect of the present invention, preferably, the movement speed of the vehicular monitoring device between the initial position and the working position depends on the velocity of the vehicle. The faster the vehicle runs, the faster the vehicular monitoring device moves. As such, the driver can realize the environment situation quickly. For efficiently achieving the above purpose, a vehicular digital bus such as a controller area network (CAN) or a vehicular area network (VAN) bus is preferred used to transfer signals, e.g. the positioning signal, velocity-indicating signal, motor-actuating signal, etc.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A device for actuating and positioning a vehicular monitoring device responsive to a vehicular status indicator, comprising:
an actuating device in communication with said vehicular status indicator and said vehicular monitoring device, actuating said vehicular monitoring device to move from an initial position to a working position in response to a first operation status of said vehicular status indicator, and actuating said vehicular monitoring device to return to said initial position in response to a second operation status of said vehicular status indicator; and
a positioning device in communication with said vehicular monitoring device and said actuating device, asserting a positioning signal to said actuating device according to a current position of said vehicular monitoring device for the reference of said actuating device.

2. The device according to claim 1 wherein said first operation status of said vehicular status indicator is an enabled status, and said second operation status is a disabled status.

3. The device according to claim 1 wherein said positioning signal is referred by said actuating device to precisely locate said initial position.

4. The device according to claim 1 wherein said current position of said vehicular monitoring device is determined according to an electric potential signal outputted by said vehicular monitoring device.

5. The device according to claim 1 wherein said current position of said vehicular monitoring device is determined according to the pulse number of a bi-level square-wave signal outputted by said vehicular monitoring device.

6. The device according to claim 1 wherein said positioning device includes a proximity switch that is disposed at a position corresponding to said initial position.

7. The device according to claim 1 wherein said positioning device includes a peak detector.

8. The device according to claim 1 wherein said vehicular monitoring device is a rearview mirror.

9. The device according to claim 1 wherein said vehicular monitoring device is an assembly of a camera and a display.

10. The device according to claim 1 wherein said vehicular status indicator is one selected from a group consisting of an electronic compass, a global positioning system (GPS), a telematics system, an attitude indicator, a vehicle stability control system, and a yaw sensor included in an electronic stability program (ESP).

11. The device according to claim 1 wherein said positioning signal is transmitted via a vehicular cable system or a vehicular digital bus.

12. The device according to claim 1 wherein a movement speed of said vehicular monitoring device between said initial position and said working position depends on a velocity of the vehicle.

13. A method for actuating and positioning a vehicular monitoring device responsive to a vehicular status indicator, comprising steps of:
actuating said vehicular monitoring device to move from an initial position to a working position in response to a first operation status of said vehicular status indicator;
actuating said vehicular monitoring device to move from said working position toward said working position in response to a second operation status of said vehicular status indicator; and
asserting a positioning signal according to a current position of said vehicular monitoring device on the way from said working position to said initial position for precisely locating said initial position.

14. The method according to claim 13 wherein an electric potential outputted by said vehicular monitoring device is used to indicate said current position of said vehicular monitoring device.

15. The method according to claim 13 wherein a pulse number of a bi-level square-wave signal outputted by said vehicular monitoring device is used to indicate said current position of said vehicular monitoring device.

16. The method according to claim 13 wherein said positioning signal is asserted when said vehicular monitoring device approaches said initial position to a certain extent.

17. The method according to claim 13 wherein said step for asserting said positioning signal includes sub-steps of:
detecting and recording a first and a second periods of time T1 and T2 for said vehicular monitoring device to move and return between two dead ends, respectively, under a constant power source;
recording a third period of time T3 for said vehicular monitoring device to move from said initial position to said working position under said constant power source;
calculating a fourth period of time T4 for said vehicular monitoring device to move from said working position to said initial position under said constant power source by using said first, second and third periods of time T1, T2 and T3 to perform an interpolation method; and
asserting said positioning signal according to said fourth period of time T4 .

18. The method according to claim 13 wherein said first operation status of said vehicular status indicator is an enabled status, and said second operation status is a disabled status.

19. A method for actuating and positioning a vehicular monitoring device responsive to a vehicular status indicator, comprising steps of:
presetting a first and a second actuating power for moving and returning said vehicular monitoring device between an initial position and a working position, said first and said second actuating powers are different from each other;
actuating said vehicular monitoring device to move from said initial position to said working position with said first electric level of actuating voltage in response to a first operation status of said vehicular status indicator; and
actuating said vehicular monitoring device to move from said working position to said working position with said second electric level of actuating voltage in response to a second operation status of said vehicular status indicator.

20. The method according to claim 19 wherein the difference of said first and said second actuating power are conducted by providing different electric levels of actuating voltages.

21. The method according to claim 20 wherein the difference of said first and said second actuating power are conducted by a dip switch.

22. The method according to claim 19 wherein the difference of said first and said second actuating power are conducted by providing a constant electric level of actuating voltage for different periods of time.

23. The method according to claim 22 wherein the difference of said first and said second actuating power are conducted by a microcontroller.
